(19) United States
(12) Patent Application Publication
(10) Pub. No.: US 2014/0300904 A1
(43) Pub. Date: Oct. 9, 2014

(54) MEASUREMENT APPARATUS

(71) Applicant: CANON KABUSHIKI KAISHA, Tokyo (JP)

(72) Inventor: Hiroyuki YUKI, Utsunomiya-shi (JP)

(73) Assignee: CANON KABUSHIKI KAISHA, Tokyo (JP)

(21) Appl. No.: 14/242,949

(22) Filed: Apr. 2, 2014

(30) Foreign Application Priority Data
Apr. 5, 2013 (JP) 2013-079924

(51) Int. Cl. G01B 9/02; G01B 11/14

(52) U.S. Cl. CPC G01B 9/02015; G01B 11/14
USPC 356/498

(57) ABSTRACT

The present invention provides a measurement apparatus including a first optical system configured to allow a first test light to pass, and a second optical system configured to allow a second test light to pass, wherein an optical power in the first optical system and an optical power in the second optical system are different, a distance between a focal point of the first test light on a side of the surface to be measured and the surface to be measured changes in accordance with each of a plurality of wavelengths of the first test light, and a distance between a focal point of the second test light on the side of the surface to be measured and the surface to be measured changes in accordance with each of a plurality of wavelengths of the second test light.

### BACKGROUND OF THE INVENTION

1. Field of the Invention

The present invention relates to a measurement apparatus which measures a distance corresponding to the optical path length difference between test light and reference light.

2. Description of the Related Art

A spectral interferometer and wavelength scanning interferometer are known as measurement apparatuses which measure a distance corresponding to the optical path length difference between test light and reference light. The spectral interferometer separates and detects interference light between test light and reference light by using a light source which emits light containing a plurality of wavelengths. Based on an interference signal (interference signal for each wavelength) containing information such as the intensity and phase of the interference light, the spectral interferometer obtains a distance corresponding to the optical path length difference between the test light and the reference light. The wavelength scanning interferometer detects the intensity and phase of interference light between test light and reference light by using a light source capable of scanning (changing) the wavelength. Based on an interference signal obtained for each wavelength by scanning the wavelength, the wavelength scanning interferometer obtains a distance corresponding to the optical path length difference between the test light and the reference light.

To improve the resolution in the lateral direction to a surface to be measured (resolution in the plane direction perpendicular to the direction of a distance to be measured) and the measurement accuracy in the measurement apparatus such as the spectral interferometer or wavelength scanning interferometer, it suffices to decrease the irradiation spot diameter of light irradiating the surface to be measured. The irradiation spot diameter can be decreased by increasing the numerical aperture (NA) of an irradiation optical system for irradiating a surface to be measured with light. However, the increase in numerical aperture decreases the focal depth, narrowing the measurable range for a distance corresponding to the optical path length difference between test light and reference light. In this manner, the measurement accuracy (irradiation spot diameter) and the measurable range have a tradeoff, and it is difficult to achieve high measurement accuracy and a wide measurable range.

As a technique capable of achieving high measurement accuracy and a wide measurable range, a spectral interferometer having a chromatic confocal arrangement has been proposed in “Chromatic confocal spectral interferometry, APPLIED OPTICS, VOL. 45, No. 32, pp. 8244-8252 (2006)” (literature 1). The chromatic confocal arrangement is an arrangement including an optical system configured to generate axial chromatic aberration, and a confocal filter. Techniques for improving the measurement accuracy in the wavelength scanning interferometer by acquiring interference signals in discrete wavelength bands and calculating a distance corresponding to the optical path length difference between test light and reference light based on these interference signals have also been proposed in Japanese Patent Laid-Open No. 2008-128707 and “Frequency Scanned Interferometry (FSI): The basis of a survey system for ATLAS using fast automated remote interferometry, Nuclear Instruments and Methods in Physics Research Section A: Accelerators, Spectrometers, Detectors and Associated Equipment, Vol. 383, Issue 1, pp. 229-237 (1996)” (literature 2).

However, the technique disclosed in literature 1 can detect, by the chromatic confocal principle, only an interference signal in a limited wavelength band having a focal point (image point) near a surface to be measured. It is difficult to ensure an interference signal in a wide wavelength band necessary to perform high-accuracy distance measurement. Thus, a measurement error increases, and a distance corresponding to the optical path length difference between test light and reference light cannot be measured at high accuracy.

To solve a problem that the wavelength band used for measurement cannot be satisfactorily ensured and the measurement accuracy drops, there has conventionally been known a technique of calculating a distance based on interference signals in discrete wavelength bands, as in Japanese Patent Laid-Open No. 2008-128707 and literature 2. However, these techniques cannot be directly applied to the technique disclosed in literature 1. This is because the detectable wavelength band is limited to a wavelength band having a focal point near a surface to be measured in the chromatic confocal principle. Thus, a discrete wavelength band from this wavelength band is blocked by the confocal filter, and an interference signal in the discrete wavelength band cannot be obtained.

### SUMMARY OF THE INVENTION

The present invention provides a technique advantageous for measuring a distance corresponding to the optical path length difference between test light and reference light at high accuracy.

According to one aspect of the present invention, there is provided a measurement apparatus which measures a distance corresponding to an optical path length difference between test light and reference light, including a first optical system configured to, of first test light and second test light split from light emitted by a light source, allow the first test light to pass, a second optical system configured to allow the second test light to pass, a detector configured to detect interference light between the first test light reflected by a surface to be measured and reference light reflected by a reference surface, and interference light between the second test light reflected by the surface to be measured and reference light reflected by the reference surface, and a processor configured to obtain the distance based on the interference light detected by the detector, wherein an optical power in the first optical system and an optical power in the second optical system are different, a distance between a focal point of the first test light on a side of the surface to be measured and the surface to be measured changes in accordance with each of a plurality of wavelengths of the first test light, a distance between a focal point of the second test light on the side of the surface to be measured and the surface to be measured changes in accordance with each of a plurality of wavelengths of the second test light, and the measurement apparatus further comprises a light guide unit configured to guide, to the detector, the first test light and second test light of wavelengths corresponding to focal points at each of which the distance between the focal point and the surface to be measured is within a predetermined distance range.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a measurement apparatus in the first embodiment of the present invention.

FIGS. 2A and 2B are graphs showing an example of an interference signal obtained from interference light between test light and reference light.

FIG. 3 is a graph showing an example of the relationship between the phase of the first interference signal and the wave number.

FIG. 4 is a graph for explaining a method of deciding the slope of the phase of an interference signal.

FIG. 5 is a schematic view showing another arrangement of the measurement apparatus in the first embodiment of the present invention.

FIG. 6 is a schematic view showing the arrangement of a measurement apparatus in the second embodiment of the present invention.

FIG. 7 is a schematic view showing another arrangement of the measurement apparatus in the second embodiment of the present invention.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

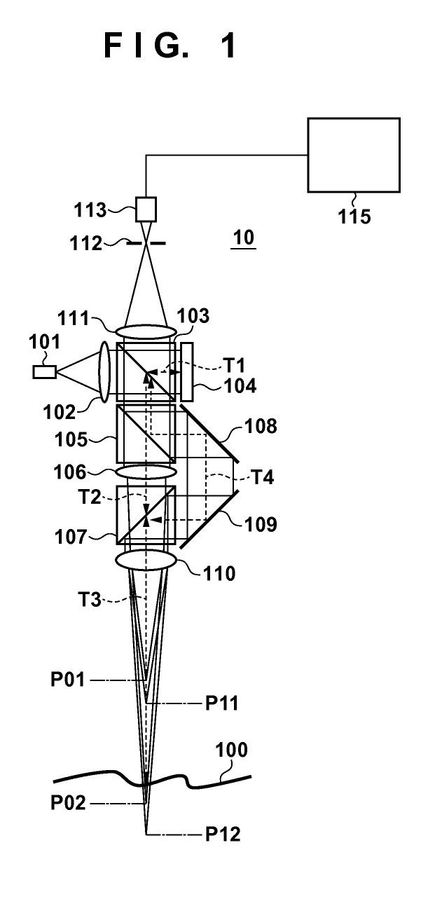

FIG. 1 is a schematic view showing the arrangement of a measurement apparatus 10 in the first embodiment of the present invention. The measurement apparatus 10 is a measurement apparatus which measures a distance corresponding to the optical path length difference between test light and reference light, and includes, for example, the arrangement of a spectral interferometer. The measurement apparatus 10 includes a light source 101 which emits light containing a plurality of wavelengths, an optical element 102, a splitting element 103, a reference surface 104, a splitting element 105, an optical element 106, a splitting element 107, reflective elements 108 and 109, and an optical element 110. The measurement apparatus 10 also includes an optical element 111, wavelength selector 112, detector 113, and processor 115.

In the measurement apparatus 10, a surface 100 to be measured is irradiated with light emitted by the light source 101 via the optical element 110 having a predetermined axial chromatic aberration. In the measurement apparatus 10, the detector 113 detects interference light between light reflected by the surface 100 to be measured and light reflected by the reference surface 104. Based on an interference signal obtained from the interference light, the processor 115 calculates a distance corresponding to the optical path length difference between test light and reference light.

Details of the arrangement of the measurement apparatus 10 will be explained along the path of light emitted by the light source 101. Light emitted by the light source 101 is collimated by the optical element 102 and enters the splitting element 103. The splitting element 103 splits the light emitted by the light source 101 into test light toward the splitting element 105 and reference light toward the reference surface 104. The splitting element 105 splits the test light into the first test light toward the optical element 106 and the second test light toward the reflective element 108.

For descriptive convenience, a path on which light passes through the splitting element 105, optical element 106, splitting element 107, optical element 110, and surface 100 to be measured in the order named or in a reverse order will be called the first path. Similarly, a path on which light passes through the splitting element 105, reflective element 108, reflective element 109, splitting element 107, optical element 110, and surface 100 to be measured in the order named or in a reverse order will be called the second path.

In the measurement apparatus 10, the optical power in the first optical system corresponding to the first test light is different from the optical power in the second optical system corresponding to the second test light, which will be described later. The first and second optical systems include a common portion at which part of the path of the first test light and part of the path of the second test light are common.

On the first path, the optical element (for example, a lens) 106 having an optical power adds a refractive power to the first test light, and the optical element (for example, a lens) 110 having an optical power adds axial chromatic aberration to the first test light. Then, the first test light forms focal points (image points) at different positions on the surface 100 to be measured in accordance with respective wavelengths (that is, for respective wavelengths). The first test light reflected by the surface 100 to be measured passes through the first path, and enters the wavelength selector 112 sequentially through the splitting element 103 and optical element 111.

The second test light passes through the second path. The optical element 110 adds axial chromatic aberration to the second test light. Then, the second test light forms focal points (image points) at different positions on the surface 100 to be measured in accordance with respective wavelengths (that is, for respective wavelengths). The second test light reflected by the surface 100 to be measured passes through the second path, and enters the wavelength selector 112 sequentially through the splitting element 103 and optical element 111.

To the contrary, the reference light is reflected by the reference surface 104, and enters the wavelength selector 112 sequentially through the splitting element 103 and optical element 111.

The light source 101 is constructed by, for example, a lamp, LED, SLD, or white laser. The splitting elements 103, 105, and 107 are constructed by, for example, beam splitters. In FIG. 1, a semi-reflective/semi-transmissive surface is indicated by an oblique line. As described above, the optical element 110 has axial chromatic aberration, and the aberration amount is set (adjusted) to satisfy the measurable range in a wavelength band used to measure a distance corresponding to the optical path length difference between test light and reference light. In other words, the measurable range can be widened by increasing the axial chromatic aberration amount of the optical element 110.

The wavelength selector 112 is constructed by, for example, a pinhole plate having a pinhole arranged at a position optically conjugate to the focal point of test light that is formed on the side of the surface to be measured. In this case, the wavelength selector 112 selects a wavelength (wavelength band) by using a so-called chromatic confocal principle in which only light of a specific wavelength band can pass through the pinhole. The wavelength selector 112 guides light corresponding to this wavelength to the detector 113.

The chromatic confocal principle utilizes the fact that test light, to which the optical element 110 adds axial chromatic aberration, forms focal points at different distances (distances between the focal point and the surface to be measured) on the side of the surface to be measured for respective wavelengths. Positions optically conjugate to the focal points of light beams of respective wavelengths on the side of the surface to be measured are the same position. At this optically conjugate position, the pinhole is arranged. Considering the path of test light reflected by the surface 100 to be measured, only light of a wavelength that forms a focal point near the surface 100 to be measured forms a focal point near the pinhole in practice, and can pass through the pinhole without being blocked by the pinhole. In contrast, light beams of other wavelengths (wavelengths other than one at which the focal point is formed near the surface 100 to be measured) are reflected by the surface to be measured which exists at a position spaced apart from the focal point. The light beams therefore form blurred images on the pinhole plane, and most of them are blocked by the pinhole and cannot pass through it. By using this principle, only test light of a wavelength band that forms a focal point near the surface 100 to be measured can be selected. In other words, the wavelength selector 112 functions as a light guide unit which guides, to the detector 113, the first test light and second test light of wavelengths corresponding to focal points at each of which the distance between the focal point and the surface 100 to be measured is equal to or smaller than a predetermined distance.

The arrangement of the wavelength selector 112 is not limited to the pinhole plate in which the pinhole is formed, but may be a small opening for selecting a wavelength band for forming a focal point near the surface 100 to be measured. For example, the wavelength selector 112 may be constructed by an optical fiber having a small incident port (small opening), and the incident port may be arranged at a position optically conjugate to the focal point of light of each wavelength on the side of the surface to be measured.

In the embodiment, the wavelength selector 112 is constituted by arranging, for the focal point of the first test light on the side of the surface to be measured, the pinhole at an optically conjugate position on a path on which the first test light passes through the first path and enters the wavelength selector 112 sequentially through the splitting element 103 and optical element 111. This arrangement (pinhole position) coincides with even an optically conjugate position for the focal point of the second test light on the side of the surface to be measured on a path on which the second test light passes through the second path and enters the wavelength selector 112 sequentially through the splitting element 103 and optical element 111.

In this arrangement, even if the first test light reflected by the surface 100 to be measured passes through the second path and enters the wavelength selector 112 sequentially through the splitting element 103 and optical element 111, an optically conjugate position on this path is different from the position of the wavelength selector 112. This is because the first test light reflected by the surface 100 to be measured does not pass through the optical element 106 having an optical power on a path on which the first test light passes through the second path and passes sequentially through the splitting element 103 and optical element 111. Thus, the focal distance changes by a corresponding amount. Most of the first test light having passed through this path is blocked by the wavelength selector 112 and does not reach the detector 113. Similarly, even if the second test light reflected by the surface 100 to be measured passes through the first path and enters the wavelength selector 112 sequentially through the splitting element 103 and optical element 111, an optically conjugate position on this path is different from the position of the wavelength selector 112. This is because the second test light reflected by the surface 100 to be measured passes through the optical element 106 on a path on which the second test light passes through the first path and passes sequentially through the splitting element 103 and optical element 111. Thus, the focal distance changes by a corresponding amount. Most of the second test light having passed through this path is blocked by the wavelength selector 112 and does not reach the detector 113.

The detector 113 receives, via the wavelength selector 112, the first test light which passes through the first path before and after reflection by the surface 100 to be measured, the second test light which passes through the second path before and after reflection by the surface 100 to be measured, and reference light reflected by the reference surface 104. The detector 113 separates and detects these interference light between the first test light, the second test light, and the reference light. The detector 113 is constructed by, for example, a spectrometer having an optical array sensor such as a CCD or CMOS sensor, and an AWG (Arrayed Waveguide Grating).

Assume that the light source 101 emits light of a wavelength band from a wavelength λL to a wavelength λH. In this case, as for the first test light, light of the wavelength λL forms a focal point at a position P01, and light of the wavelength λH forms a focal point at a position P02 under the influence of the optical element 110 having axial chromatic aberration. Light of a wavelength between the wavelength λL and the wavelength λH forms a focal point between the positions P01 and P02. As for the second test light, the focal length is different from that of the first test light under the influence of the refractive power of the optical element 106. Thus, light of the wavelength λL forms a focal point at a position P11, and light of the wavelength λH forms a focal point at a position P12. The splitting element 107 forms, on the same axis, the positions of the focal points of the first test light and second test light on the side of the surface to be measured.

In the measurement apparatus 10, when light beams of the same wavelength are compared, the position of the focal point of the first test light differs from that of the focal point of the second test light. In other words, the wavelength band of the first test light forming a focal point near the surface 100 to be measured is different from that of the second test light forming a focal point near the surface 100 to be measured. For this reason, an interference signal obtained from interference light detected by the detector 113 can be separated into the contribution of the first test light and the contribution of the second test light in accordance with the difference between these wavelengths.

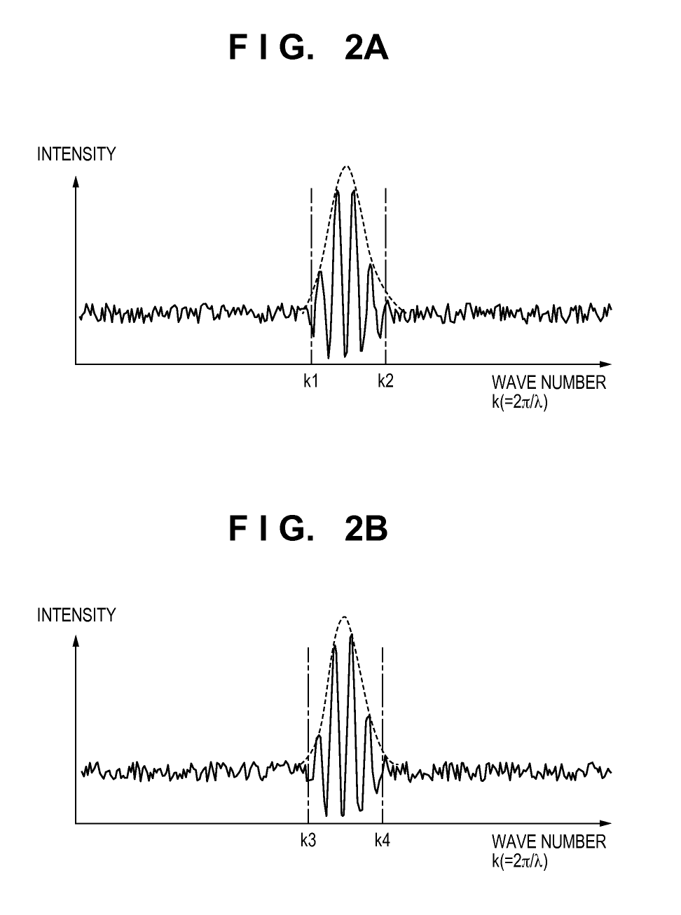

For example, FIG. 2A is a graph showing a signal containing an interference signal corresponding to interference light between the first test light and reference light. FIG. 2B is a graph showing a signal containing an interference signal corresponding to interference light between the second test light and reference light. In FIGS. 2A and 2B, a wave number k is adopted for the abscissa, and the intensity of light (interference light) detected by the detector 113 is adopted for the ordinate. The wave number k is given using the wavelength λ and the circular constant π:

k=2π/λ (1)

In the following description, the wavelength is replaced by the wave number using equation (1).

Based on the chromatic confocal principle, only test light of a wave number band that forms a focal point near the surface 100 to be measured can pass through the wavelength selector 112 and be detected as interference light (interference signal) with reference light. In FIG. 2A, a wave number band in which a periodic signal by interference can be obtained is a wave number band from a wave number k1 to a wave number k2 in which the focal point is formed near the surface 100 to be measured, out of wave numbers from a wave number kL (kL=2λ/λL) to a wave number kH (kH=2π/λH). The first test light in a wave number band other than the wave number band from the wave number k1 to the wave number k2 is blocked by the wavelength selector 112 and cannot be detected as interference light (interference signal) with reference light.

Similarly, in FIG. 2B, the wave number band in which a periodic signal by interference can be obtained is a wave number band from a wave number k3 to a wave number k4 in which the focal point is formed near the surface 100 to be measured. The second test light in a wave number band other than the wave number band from the wave number k3 to the wave number k4 is blocked by the wavelength selector 112 and cannot be detected as interference light (interference signal) with reference light.

As described above, the first test light and second test light have different focal lengths because of the action of the optical element 106, and the positions of focal points by light beams of the same wavelength do not coincide with each other. More specifically, the wave numbers k1 to k2 of the first test light forming a focal point near the surface 100 to be measured are different from the wave numbers k3 to k4 of the second test light forming a focal point near the surface 100 to be measured. The optical element 106 is configured so that, for example, k3, k4>k1, k2, or k3, k4<k1, k2 is satisfied, that is, the wavelength bands of these two light beams do not coincide with each other. In the following description, k3, k4>k1, k2.

An example of a method of calculating a distance corresponding to the optical path length difference between test light and reference light from a periodic interference signal for the wave number k will be explained. First, an interference signal I is given by:

$$\begin{matrix}I ( k ) = {A}^{2} + {B}^{2} + AB cos ( {φ}^{′} ) & ( 2 ) \\ \begin{matrix}{φ}^{′} = 2 kL \\ = 2 π M + φ\end{matrix} & \end{matrix}$$

where A is the amplitude intensity of reference light, B is the amplitude intensity of test light, φ′ is the phase of the interference signal, M is the interference order, φ is the fractional component of the phase (to be referred to as a “fractional phase” hereinafter) of an interference signal falling within the range of ±π, and L is the distance corresponding to the optical path length difference between test light and reference light. In this case, assume that the refractive index of the space is 1 and there is no dispersion.

As disclosed in literature 1, the distance L can be obtained from the peak frequency of the spectrum of the amplitude of the interference signal by performing fast Fourier transform (FFT) for the interference signal I. When obtaining the peak frequency in this way, if the wave number range where the interference signal can be obtained is wide, the peak frequency can be obtained at high accuracy. However, if the wave number range where the interference signal can be obtained is limited to a narrow range, as shown in FIG. 2A, an error readily occurs, and the peak frequency cannot be obtained at high accuracy. Therefore, the distance L corresponding to the optical path length difference between test light and reference light cannot be obtained at high accuracy.

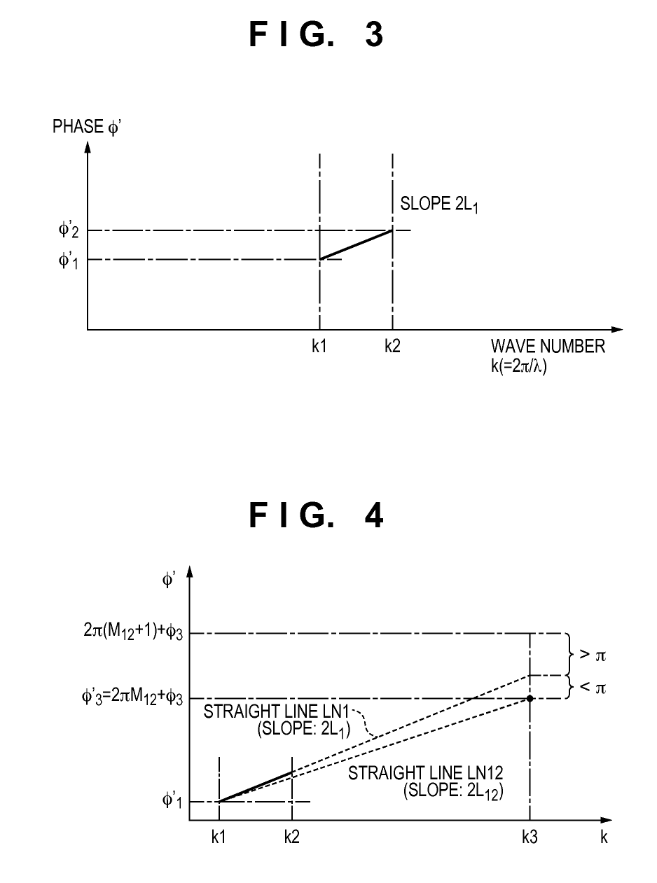

In the first embodiment, a distance corresponding to the optical path length difference between test light and reference light can be obtained at high accuracy by processing to be described below. First, the peak frequency in the amplitude spectrum is decided by performing fast Fourier transform (FFT) for an interference signal I₁ (to be referred to as a “first interference signal I₁” hereinafter) shown in FIG. 2A. A distance L₁ is decided from this peak frequency. Referring to equation (2), double the distance L₁ (2L₁) is equivalent to the slope of the phase φ′ of the first interference signal I₁ with respect to the wave number k, as shown in FIG. 3.

Then, the fractional phase φ of the first interference signal I₁ at an arbitrary wave number k is decided by performing discrete Fourier transform (DFT) for the first interference signal I₁ by using the distance L₁. More specifically, the fractional phase φ of the first interference signal I₁ is decided by:

$$φ ( k ) = {tan}^{- 1} \frac{{\sum }_{j} {I}_{1} ( j ) sin \{ 2 {L}_{1} ( j - k ) \}}{{\sum }_{j} {I}_{1} ( j ) cos \{ 2 {L}_{1} ( j - k ) \}} \\ j = k 1 \sim k 2 \qquad ( 3 )$$

Referring to equation (3), a fractional phase (first fractional phase) at an arbitrary wave number between the wave numbers k1 and k2, such as a fractional phase φ₁ (φ₁′=2πM₁+φ₁) at the wave number k1 or a fractional phase φ₂ (φ₂′=2πM₂+φ₂) at the wave number k2, can be decided.

After that, the same processing as that for the first interference signal I₁ is performed for an interference signal I₂ (to be referred to as a “second interference signal I₂” hereinafter) in FIG. 2B. A distance L₂ is decided based on the second interference signal I₂. The distance L₂ is essentially different from the distance L₁ and requires correction processing. Strictly speaking, a distance corresponding to the optical path length difference between test light and reference light is the difference in the distance of an uncommon optical path between test light and reference light on the path through which the reference light and test light pass.

In FIG. 1, T1 is the distance between the reference surface 104 and the splitting element 103, and T2 is the distance between the splitting element 103 and the splitting element 107 along the first path. Also, T3 is the distance between the splitting element 107 and the surface 100 to be measured, and T4 is the distance between the splitting element 103 and the splitting element 107 along the second path.

As for the first test light, the distance of an optical path uncommon to the reference light is 2×(T2+T3). As for the reference light, the distance of an optical path uncommon to the first test light is 2×T1. From this, a distance corresponding to the optical path length difference between the first test light and the reference light is 2×(T2+T3−T1).

As for the second test light, the distance of an optical path uncommon to the reference light is 2×(T4+T3). As for the reference light, the distance of an optical path uncommon to the second test light is 2×T1. Therefore, a distance corresponding to the optical path length difference between the second test light and the reference light is 2×(T4+T3−T1).

In this fashion, a distance corresponding to the optical path length difference between the second test light and the reference light is different by 2×(T4−T2) from a distance corresponding to the optical path length difference between the first test light and the reference light. In this case, T2 and T4 are distances in the internal arrangement of the measurement apparatus 10, can be acquired from design values, preliminary measurement, or the like, and are known amounts. By using T2 and T4, the distance L₂ calculated from an interference signal can be corrected to L₂′. The correction equation is 2×L₂′=2×L₂−2×(T4−T2). Substituting 2×L₂=2×(T4+T3−T1) into this correction equation reveals that, if there is no measurement error, L₂′ essentially becomes equal to 2×L₁=2×(T2+T3−T1).

The correction processing can also be omitted by inserting a deflecting mirror or the like in the first or second path to adjust the optical path, and configuring in advance the measurement apparatus 10 to satisfy T4−T2=0.

Based on the corrected distance L₂′, a fractional phase (second fractional phase) at an arbitrary wave number between the wave numbers k3 and k4 is decided. Here, assume that a fractional phase φ₃ at the wave number k3 is decided as the second fractional phase.

A method of deciding a slope L₁₂ of the corrected phase will be explained with reference to FIG. 4. In FIG. 4, a straight line LN1 is a straight line decided by the phase φ₁′ (φ₁′=2πM₁+φ₁) of the first interference signal I₁ at the decided wave number k1, and a slope 2L₁ of the phase. The interference order M₁ may be set to be an arbitrary value. A straight line LN2 is a straight line decided by a phase φ₃′ given by φ₃′=2π(M₁₂+M₁)+φ₃ and the phase φ₁′. M₁₂ is the interference order difference between the first interference signal I₁ at the wave number k1 and the second interference signal I₂ at the wave number k3, and is given by:

$${M}_{12} = round \{ \frac{2 {L}_{1} ( k 3 - k 1 ) + {φ}_{1} - {φ}_{3}}{2 π} \} \qquad ( 4 )$$

where “round( )” is the function of rounding an argument to an integer.

A distance L₁₂ is decided from the slope of the straight line LN2 by using M₁₂ decided in accordance with equation (4). More specifically, the distance L₁₂ is decided by:

$$\begin{matrix}{L}_{12} = \frac{1}{2} \frac{{φ}_{3}^{′} - {φ}_{1}^{′}}{k 3 - k 1} \\ = \frac{1}{2} \frac{2 π {M}_{12} + {φ}_{3} - {φ}_{1}}{k 3 - k 1}\end{matrix} \qquad ( 5 )$$

The decided distance L₁₂ has the same accuracy as that of a distance calculated based on an interference signal which exists in the range of the wave number k1 to the wave number k3. The range of wave numbers is wider than that for the distance L₁ calculated from an interference signal between the wave numbers k1 and k2. Accordingly, a distance corresponding to the optical path length difference between test light and reference light can be obtained at high accuracy.

In the embodiment, the straight line LN1 is a straight line decided by the slope 2L₁ of the phase at the wave number k1, but is not limited to this. For example, the straight line LN1 may be a slope 2L₃ of the phase calculated for the second interference signal I₂ or the average value (2L₁+2L₃)/2 of the slopes L₁ and L₃ of the phase.

Processing for the first interference signal I₁ and second interference signal I₂ is not limited to the above-described processing. The processing can be changed for the purpose of calculating a distance at higher accuracy by using interference signals in a plurality of discrete wavelength bands, compared to a case in which the distance is calculated from an interference signal in one wavelength band. For example, the technique disclosed in Japanese Patent Laid-Open No. 2008-128707 or literature 2 may be applied.

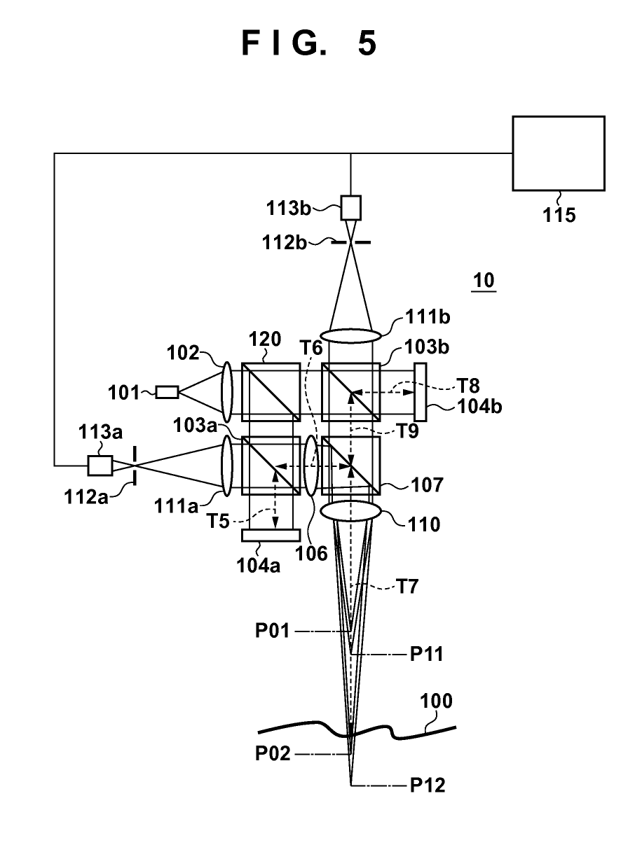

The measurement apparatus 10 shown in FIG. 1 includes one reference surface 104, but is not limited to this. For example, as shown in FIG. 5, the measurement apparatus 10 may include a plurality of reference surfaces 104a and 104b. FIG. 5 is a schematic view showing another arrangement of the measurement apparatus 10 in the first embodiment of the present invention.

Referring to FIG. 5, light emitted by the light source 101 is collimated by the optical element 102 and enters a splitting element 120. The splitting element 120 splits the light emitted by the light source 101 into light toward a splitting element 103a and light toward a splitting element 103b. For descriptive convenience, a path on which light passes through the splitting element 103a, optical element 106, splitting element 107, optical element 110, and surface 100 to be measured in the order named or in a reverse order will be called the third path. Similarly, a path on which light passes through the splitting element 103b, splitting element 107, optical element 110, and surface 100 to be measured in the order named or in a reverse order will be called the fourth path.

Light traveling from the splitting element 120 to the splitting element 103a is split by the splitting element 103a into the first reference light toward the reference surface 104a and the first test light toward the optical element 106. On the third path, the optical element 106 having an optical power adds a refractive power to the first test light, and the optical element 110 having an optical power adds axial chromatic aberration to the first test light. Then, the first test light forms focal points (image points) at different positions on the surface 100 to be measured in accordance with respective wavelengths (that is, for respective wavelengths). The first test light reflected by the surface 100 to be measured passes through the third path, and enters a wavelength selector 112a through an optical element 111a. In contrast, the first reference light is reflected by the reference surface 104a, and enters the wavelength selector 112a sequentially through the splitting element 103a and optical element 111a.

Light traveling from the splitting element 120 to the splitting element 103b is split by the splitting element 103b into the second reference light toward the reference surface 104b and the second test light toward the splitting element 107. On the fourth path, the optical element 110 adds axial chromatic aberration to the second test light. Then, the second test light forms focal points (image points) at different positions on the surface 100 to be measured in accordance with respective wavelengths (that is, for respective wavelengths). The second test light reflected by the surface 100 to be measured passes through the fourth path, and enters a wavelength selector 112b through an optical element 111b. To the contrary, the second reference light is reflected by the reference surface 104b, and enters the wavelength selector 112b sequentially through the splitting element 103b and optical element 111b.

The wavelength selector 112a is constructed by a pinhole plate having a pinhole arranged at a position conjugate to a focal point formed on the side of the surface to be measured on a path on which the first test light reflected by the surface 100 to be measured enters the wavelength selector 112a sequentially through the third path and the optical element 111a. The wavelength selector 112b is constructed by a pinhole plate having a pinhole arranged at a position conjugate to a focal point formed on the side of the surface to be measured on a path on which the second test light reflected by the surface 100 to be measured enters the wavelength selector 112b sequentially through the fourth path and the optical element 111b.

Even if the first test light reflected by the surface 100 to be measured passes through the fourth path and enters the wavelength selector 112b through the optical element 111b, a conjugate position on this path is different from the position of the wavelength selector 112b. This is because the first test light reflected by the surface 100 to be measured does not pass through the optical element 106 on a path on which the first test light passes through the fourth path and also passes through the optical element 111b. Thus, the focal distance changes by a corresponding amount. Most of the first test light having passed through this path is blocked by the wavelength selector 112b and does not reach a detector 113b.

Similarly, even if the second test light reflected by the surface 100 to be measured passes through the third path and enters the wavelength selector 112a through the optical element 111a, a conjugate position on this path is different from the position of the wavelength selector 112a. This is because the second test light reflected by the surface 100 to be measured passes through the optical element 106 on a path on which the second test light passes through the third path and passes through the optical element 111a. The focal distance therefore changes by a corresponding amount. Most of the second test light having passed through this path is blocked by the wavelength selector 112a and does not reach a detector 113a.

The detector 113a receives, via the wavelength selector 112a, only interference light between the first test light and the first reference light. The detector 113b receives, via the wavelength selector 112b, only interference light between the second test light and the second reference light.

A distance corresponding to the optical path length difference between test light and reference light in the measurement apparatus 10 shown in FIG. 5 will be explained. In FIG. 5, T5 is the distance between the reference surface 104a and the splitting element 103a, and T6 is the distance between the splitting element 103a and the splitting element 107 on the third path. Also, T7 is the distance between the splitting element 107 and the surface 100 to be measured, T8 is the distance between the reference surface 104b and the splitting element 103b, and T9 is the distance between the splitting element 103b and the splitting element 107 on the fourth path.

As for the first test light, the distance of an optical path uncommon to the first reference light is 2×(T6+T7). As for the first reference light, the distance of an optical path uncommon to the first test light is 2×T5. From this, a distance corresponding to the optical path length difference between the first test light and the first reference light is 2×(T6+T7−T5).

As for the second test light, the distance of an optical path uncommon to the second reference light is 2×(T9+T7). As for the second reference light, the distance of an optical path uncommon to the second test light is 2×T8. From this, a distance corresponding to the optical path length difference between the second test light and the second reference light is 2×(T9+T7−T8).

In this manner, a distance corresponding to the optical path length difference between the second test light and the second reference light is different by 2×(T9−T8−T6+T5) from a distance corresponding to the optical path length difference between the first test light and the first reference light. In this case, T5, T6, T8, and T9 are distances in the internal arrangement of the measurement apparatus 10, can be acquired from design values, preliminary measurement, or the like, and are known amounts. The distance corresponding to the optical path length difference between test light and reference light in the second test light and the second reference light can therefore be corrected by a correction equation given by 2×L₂′=2×L₂−2×(T9−T8−T6+T5). Substituting 2×L₂=2×(T9+T7−T8) into this correction equation reveals that, if there is no measurement error, L₂′ essentially becomes equal to 2×L₁=2×(T6+T7−T5).

The correction processing can also be omitted by configuring in advance the measurement apparatus 10 to satisfy T9−T8−T6+T5=0. Since the reference surfaces 104a and 104b are constructed independently, the measurement apparatus 10 shown in FIG. 5 is higher in the degree of freedom of the arrangement than the measurement apparatus 10 shown in FIG. 1, and can be relatively easily changed and adjusted to an arrangement which satisfies T9−T8−T6+T5=0.

The embodiment has described an arrangement which splits test light into two light beams, but the present invention is not limited to this. For example, an arrangement is also possible, which splits test light into three or more light beams and has axial chromatic aberrations giving different focal lengths for the three or more respective test light beams. When test light is split into a plurality of light beams, interference signals are obtained by the number of wave numbers. A distance corresponding to the optical path length difference between test light and reference light can be measured at higher accuracy.

In the embodiment, the optical element 106 makes different the focal length of the first test light and that of the second test light, and the optical element 110 adds axial chromatic aberrations to the first test light and second test light, respectively. However, the present invention is not limited to this. The arrangement can be changed for the purpose of adding axial chromatic aberrations to the respective test light beams to form focal points at different positions for the respective wavelengths, and forming focal points at different positions by the respective test light beams at the same wavelength. For example, in the measurement apparatus 10 shown in FIG. 1, optical systems (optical elements) having axial chromatic aberration may be inserted in both the first and second paths, instead of the optical element 110. Instead of the optical element 106 and the optical element 102 which collimates light, an optical element which does not collimate light may be arranged at the position of the optical element 102, and the position of the focal point on the side of the surface to be measured at the same wavelength may be changed in accordance with the distance difference between the first and second paths. In the measurement apparatus 10 shown in FIG. 5, optical systems (optical elements) having axial chromatic aberration may be inserted in both the third and fourth paths, instead of the optical element 110. Instead of the optical element 106 and the optical element 102 which collimates light, an optical element which does not collimate light may be arranged at the position of the optical element 102, and the position of the focal point on the side of the surface to be measured at the same wavelength may be changed in accordance with the distance difference between the third and fourth paths.

In the embodiment, all the splitting elements are constructed by beam splitters, but the present invention is not limited to this. For example, the splitting element may be constructed by a splitting element whose reflection or transmission characteristic changes in accordance with the polarization state of light, for example, by a polarizing beam splitter (PBS) or the like. Also, the splitting element may be constructed by a splitting element whose reflection or transmission characteristic changes in accordance with the wavelength of light, for example, by a dichroic mirror, dichroic prism, or the like.

A case in which a dichroic mirror is applied as the splitting element in the measurement apparatus 10 shown in FIG. 1 will be examined. In this case, the splitting elements 105 and 107 are constructed by dichroic mirrors having a characteristic of reflecting light of a wavelength shorter than a wavelength λC (λL<λC<λH) and transmitting light of a wavelength longer than a wavelength λC′ (λL<λC<λC′<λH). As for the first test light, light of the wavelength λC′ forms a focal point at the position P01 by the refractive power of the optical element 106, and light of the wavelength λH forms a focal point at the position P02. As for the second test light, light of the wavelength λL forms a focal point at the position P11, and light of the wavelength λC forms a focal point at the position P12. Since the first test light and second test light have different wavelengths because of the action of the dichroic mirrors, the refractive power of the optical element 106 may be adjusted to make the positions P01 and P11 coincide with each other. Similarly, the refractive power of the optical element 106 may be adjusted to make the positions P02 and P12 coincide with each other.

In this arrangement, the first test light and second test light reflected by the surface 100 to be measured pass through the same paths as those before reflection and reach the splitting element 103. As a result, unwanted light which enters the wavelength selector 112 to cause a measurement error can be reduced. When the splitting element is constructed by a beam splitter, the measurable range is from the position P11 to the position P02. However, when the splitting element is constructed by a dichroic mirror, the measurable range can be widened to be from the position P01 to the position P12.

Similarly, a case in which a dichroic mirror is applied as the splitting element in the measurement apparatus 10 shown in FIG. 5 will be examined. In this case, the splitting elements 120 and 107 are constructed by dichroic mirrors having a characteristic of reflecting light of a wavelength shorter than the wavelength λC (λL<λC<λH) and transmitting light of a wavelength longer than the wavelength λC′ (λL<λC<λC′<λH). This arrangement can reduce unwanted light causing a measurement error.

Even when a PBS is used as the splitting element, unwanted light causing a measurement error can be reduced. For example, a case in which a PBS is applied as the splitting element in the measurement apparatus 10 shown in FIG. 1 will be examined. In this case, the splitting elements 105 and 107 are constructed by PBSs. By the action of the PBSs, only P-polarized light can pass through the splitting elements 105 and 107 on the first path, and only S-polarized light can pass through the splitting elements 105 and 107 on the second path. For this reason, the first test light passing through the first path cannot pass through the second path after being reflected by the surface 100 to be measured. Similarly, the second test light passing through the second path cannot pass through the first path after being reflected by the surface 100 to be measured. This can reduce unwanted light which enters the wavelength selector 112 to cause a measurement error.

Similarly, a case in which a PBS is applied as the splitting element in the measurement apparatus 10 shown in FIG. 5 will be examined. In this case, the splitting elements 120 and 107 are constructed by PBSs. This arrangement can reduce unwanted light causing a measurement error.

When the dichroic mirror is applied as the splitting element, the optical path of test light is branched in accordance with the wavelength to prevent each test light from passing through different paths before and after reflection on the surface 100 to be measured, thereby reducing unwanted light causing a measurement error. When the PBS is applied as the splitting element, the optical path of test light is branched in accordance with polarization to prevent each test light from passing through different paths before and after reflection on the surface 100 to be measured, thereby reducing unwanted light causing a measurement error.

### Second Embodiment

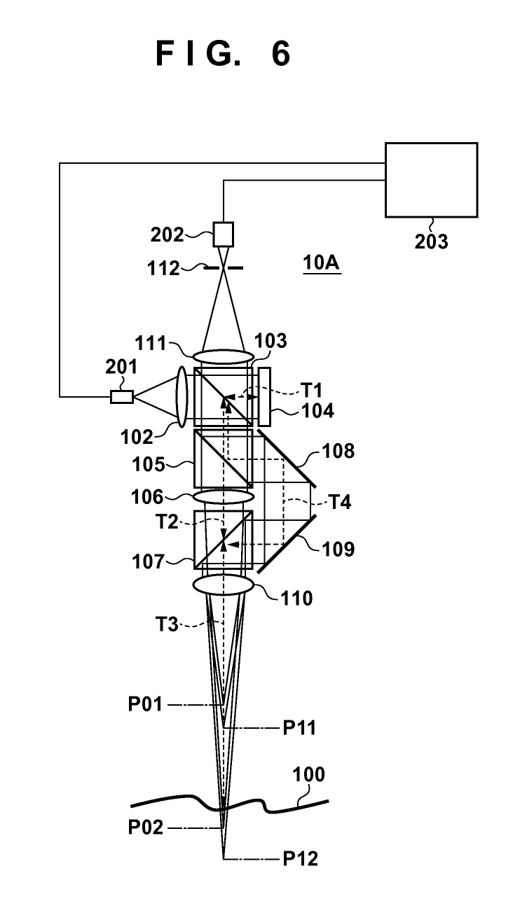

FIG. 6 is a schematic view showing the arrangement of a measurement apparatus 10A in the second embodiment of the present invention. The measurement apparatus 10A is a measurement apparatus which measures a distance corresponding to the optical path length difference between test light and reference light, and includes, for example, the arrangement of a wavelength scanning interferometer. The measurement apparatus 10A includes a light source 201 capable of changing the wavelength of light to be emitted in a wavelength band including a plurality of wavelengths, an optical element 102, a splitting element 103, a reference surface 104, a splitting element 105, an optical element 106, a splitting element 107, and reflective elements 108 and 109. The measurement apparatus 10A also includes an optical element 110, optical element 111, wavelength selector 112, detector 202, and processor 203.

In the measurement apparatus 10A, a surface 100 to be measured is irradiated via the optical element 110 with light emitted by the light source 201 capable of continuously or discretely changing the wavelength from λH to λL. In the measurement apparatus 10A, the detector 202 detects interference light between light reflected by the surface 100 to be measured and light reflected by the reference surface 104. Based on an interference signal obtained from the interference light, the processor 203 calculates a distance corresponding to the optical path length difference between test light and reference light.

The light source 201 is constructed by, for example, a tunable laser, and can change (scan) the wavelength by changing a supply voltage, supply current, or the like. The detector 202 is constructed by, for example, a photosensor such as a photodiode. The processor 203 calculates a distance corresponding to the optical path length difference between test light and reference light based on the wavelength of light emitted by the light source 201, and an interference signal (interference signal at each wavelength) which changes in accordance with wavelength scanning of light emitted by the light source 201.

In the measurement apparatus 10A, a path through which light emitted by the light source 201 passes, and a path through which light split by the splitting element passes are the same as those in the measurement apparatus 10 shown in FIG. 1 in the first embodiment. The measurement apparatus 10 shown in FIG. 1 constitutes a spectral interferometer in which light containing a plurality of wavelengths is emitted by the light source 101 and separated by the detector 113 to acquire an interference signal at each wavelength. In contrast, the measurement apparatus 10A shown in FIG. 6 includes the arrangement of the wavelength scanning interferometer which acquires an interference signal at each wavelength by scanning the wavelength of light of an almost single wavelength emitted by the light source 201. Interference signals acquired in accordance with scanning of the wavelength of light emitted by the light source 201 are aligned by adopting the wave number for the abscissa and the intensity of the interference light for the ordinate. As a result, interference signals equivalent to the first interference signal I₁ shown in FIG. 2A and second interference signal I₂ shown in FIG. 2B are obtained. Processing described in the first embodiment can be applied to processing of calculating a distance corresponding to the optical path length difference between test light and reference light based on the obtained first interference signal I₁ and second interference signal I₂. Hence, the measurement apparatus 10A can measure a distance corresponding to the optical path length difference between test light and reference light at high accuracy.

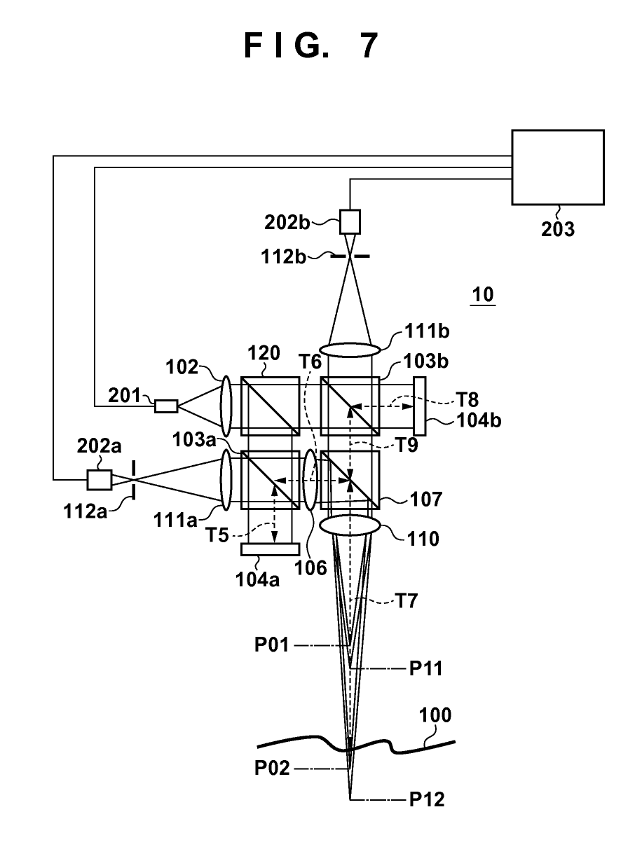

FIG. 7 is a schematic view showing another arrangement of the measurement apparatus 10A in the second embodiment of the present invention. The measurement apparatus 10A shown in FIG. 6 corresponds to the measurement apparatus 10 shown in FIG. 1. The measurement apparatus 10A shown in FIG. 7 corresponds to the measurement apparatus 10 shown in FIG. 5. In the measurement apparatus 10A shown in FIG. 7, the light source 201 can continuously or discretely change the wavelength from λH to λL. Detectors 202a and 202b detect interference light beams. Based on interference signals obtained from these interference light beams, the processor 203 calculates a distance corresponding to the optical path length difference between test light and reference light.

In the measurement apparatus 10A shown in FIG. 7, a path through which light emitted by the light source 201 passes, and paths through which the first reference light, first test light, second reference light, and second test light pass are the same as those in the measurement apparatus 10 shown in FIG. 5 in the first embodiment. Since reference surfaces 104a and 104b are constructed independently, the measurement apparatus 10A shown in FIG. 7 is higher in the degree of freedom of the arrangement than the measurement apparatus 10A shown in FIG. 6, and can be relatively easily changed and adjusted to an arrangement which satisfies T9−T8−T6+T5=0.

The second embodiment has been described on the assumption that processing for an interference signal in the measurement apparatus 10A is the same as that in the first embodiment, but the present invention is not limited to this. The processing can be changed for the purpose of calculating a distance at higher accuracy by using interference signals in a plurality of discrete wavelength bands, compared to a case in which the distance is calculated from an interference signal in one wavelength band. For example, the technique disclosed in Japanese Patent Laid-Open No. 2008-128707 or literature 2 may be applied.

The embodiment has described an arrangement which splits test light into two light beams, but the present invention is not limited to this. For example, an arrangement is also possible, which splits test light into three or more light beams, and has axial chromatic aberrations giving different focal lengths for the three or more respective test light beams. When test light is split into a plurality of light beams, interference signals are obtained by the number of wave numbers. A distance corresponding to the optical path length difference between test light and reference light can be measured at higher accuracy.

In the embodiment, the optical element 106 makes different the focal length of the first test light and that of the second test light, and the optical element 110 adds axial chromatic aberrations to the first test light and second test light, respectively. However, the present invention is not limited to this. The arrangement can be changed for the purpose of adding axial chromatic aberrations to the respective test light beams to form focal points at different positions for the respective wavelengths, and forming focal points at different positions by the respective test light beams at the same wavelength. For example, in the measurement apparatus 10A shown in FIG. 6, optical systems (optical elements) having axial chromatic aberration may be inserted in both the first and second paths, instead of the optical element 110. Instead of the optical element 106 and the optical element 102 which collimates light, an optical element which does not collimate light may be arranged at the position of the optical element 102, and the position of the focal point on the side of the surface to be measured at the same wavelength may be changed in accordance with the distance difference between the first and second paths. In the measurement apparatus 10A shown in FIG. 7, optical systems (optical elements) having axial chromatic aberration may be inserted in both the third and fourth paths, instead of the optical element 110. Instead of the optical element 106 and the optical element 102 which collimates light, an optical element which does not collimate light may be arranged at the position of the optical element 102, and the position of the focal point on the side of the surface to be measured at the same wavelength may be changed in accordance with the distance difference between the third and fourth paths.

In the embodiment, all the splitting elements are constructed by beam splitters, but the present invention is not limited to this. For example, the splitting element may be constructed by a splitting element whose reflection or transmission characteristic changes in accordance with the polarization state of light, for example, by a polarizing beam splitter (PBS) or the like. Also, the splitting element may be constructed by a splitting element whose reflection or transmission characteristic changes in accordance with the wavelength of light, for example, by a dichroic mirror, dichroic prism, or the like.

A case in which a dichroic mirror is applied as the splitting element in the measurement apparatus 10A shown in FIG. 6 will be examined. In this case, the splitting elements 105 and 107 are constructed by dichroic mirrors having a characteristic of reflecting light of a wavelength shorter than a wavelength λC (λL<λC<λH) and transmitting light of a wavelength longer than a wavelength λC′ (λL<λC<λC′<λH). As for the first test light, light of the wavelength λC′ forms a focal point at a position P01 by the refractive power of the optical element 106, and light of the wavelength λH forms a focal point at a position P02. As for the second test light, light of the wavelength λL forms a focal point at a position P11, and light of the wavelength λC forms a focal point at a position P12. Since the first test light and second test light have different wavelengths because of the action of the dichroic mirrors, the refractive power of the optical element 106 may be adjusted to make the positions P01 and P11 coincide with each other. Similarly, the refractive power of the optical element 106 may be adjusted to make the positions P02 and P12 coincide with each other.

In this arrangement, the first test light and second test light reflected by the surface 100 to be measured pass through the same paths as those before reflection and reach the splitting element 103. Thus, unwanted light which enters the wavelength selector 112 to cause a measurement error can be reduced. When the splitting element is constructed by a beam splitter, the measurable range is from the position P11 to the position P02. However, when the splitting element is constructed by a dichroic mirror, the measurable range can be widened to be from the position P01 to the position P12.

Similarly, a case in which a dichroic mirror is applied as the splitting element in the measurement apparatus 10A shown in FIG. 7 will be examined. In this case, a splitting element 120 and the splitting element 107 are constructed by dichroic mirrors having a characteristic of reflecting light of a wavelength shorter than the wavelength λC (λL<λC<λH) and transmitting light of a wavelength longer than the wavelength λC′ (λL<λC<λC′<λH). This arrangement can reduce unwanted light causing a measurement error.

Even when a PBS is used as the splitting element, unwanted light causing a measurement error can be reduced. For example, a case in which a PBS is applied as the splitting element in the measurement apparatus 10A shown in FIG. 6 will be examined. In this case, the splitting elements 105 and 107 are constructed by PBSs. By the action of the PBSs, only P-polarized light can pass through the splitting elements 105 and 107 on the first path, and only S-polarized light can pass through the splitting elements 105 and 107 on the second path. For this reason, the first test light passing through the first path cannot pass through the second path after being reflected by the surface 100 to be measured. Similarly, the second test light passing through the second path cannot pass through the first path after being reflected by the surface 100 to be measured. This can reduce unwanted light which enters the wavelength selector 112 to cause a measurement error.

Similarly, a case in which a PBS is applied as the splitting element in the measurement apparatus 10A shown in FIG. 7 will be examined. In this case, the splitting elements 120 and 107 are constructed by PBSs. This arrangement can reduce unwanted light causing a measurement error.

When the dichroic mirror is applied as the splitting element, the optical path of test light is branched in accordance with the wavelength to prevent each test light from passing through different paths before and after reflection on the surface 100 to be measured, thereby reducing unwanted light causing a measurement error. When the PBS is applied as the splitting element, the optical path of test light is branched in accordance with polarization to prevent each test light from passing through different paths before and after reflection on the surface 100 to be measured, thereby reducing unwanted light causing a measurement error.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-079924 filed on Apr. 5, 2013, which is hereby incorporated by reference herein in its entirety.

What is claimed is:

1. A measurement apparatus which measures a distance corresponding to an optical path length difference between test light and reference light, comprising:
a first optical system configured to, of first test light and second test light split from light emitted by a light source, allow the first test light to pass;
a second optical system configured to allow the second test light to pass;
a detector configured to detect interference light between the first test light reflected by a surface to be measured and reference light reflected by a reference surface, and interference light between the second test light reflected by the surface to be measured and reference light reflected by the reference surface; and
a processor configured to obtain the distance based on the interference light detected by the detector,
wherein an optical power in the first optical system and an optical power in the second optical system are different,
a distance between a focal point of the first test light on a side of the surface to be measured and the surface to be measured changes in accordance with each of a plurality of wavelengths of the first test light,
a distance between a focal point of the second test light on the side of the surface to be measured and the surface to be measured changes in accordance with each of a plurality of wavelengths of the second test light, and
the measurement apparatus further comprises a light guide unit configured to guide, to the detector, the first test light and second test light of wavelengths corresponding to focal points at each of which the distance between the focal point and the surface to be measured is within a predetermined distance range.

2. The apparatus according to claim 1, wherein
the first optical system and the second optical system include a common portion at which part of a path of the first test light and part of a path of the second test light are common, and
the light guide unit is arranged at the common portion.

3. The apparatus according to claim 2, wherein
optical elements having different focal lengths for the first test light and the second test light are arranged at a portion of the first optical system except for the common portion, and a portion of the second optical system except for the common portion, and
an optical element having the same axial chromatic aberration for the first test light and the second test light is arranged at the common portion.

4. The apparatus according to claim 2, wherein optical elements having different axial chromatic aberrations for the first test light and the second test light are arranged at a portion of the first optical system except for the common portion, and a portion of the second optical system except for the common portion.

5. The apparatus according to claim 1, wherein the light guide unit includes a pinhole plate in which a pinhole is formed to allow, to pass, the first test light and second test light of the wavelengths corresponding to the focal points at each of which the distance between the focal point and the surface to be measured is within the predetermined distance range.

6. The apparatus according to claim 1, wherein the light guide unit includes an optical fiber having an incident port which receives the first test light and second test light of the wavelengths corresponding to the focal points at each of which the distance between the focal point and the surface to be measured is within the predetermined distance range.

7. The apparatus according to claim 1, wherein the light source includes a light source configured to emit light containing the plurality of wavelengths.

8. The apparatus according to claim 1, wherein the light source includes a light source configured to be able to change a wavelength of light to be emitted in a wavelength band including the plurality of wavelengths.

9. The apparatus according to claim 1, further comprising a beam splitter configured to split the light emitted by the light source into the first test light, the second test light, and the reference light.

10. The apparatus according to claim 1, wherein the processor obtains, based on a first interference signal obtained from the interference light between the first test light and the reference light that has been detected by the detector, a slope of a first phase serving as a slope of a phase of the first interference signal, and a fractional component of the first phase serving as the phase of the first interference signal at an arbitrary wave number contained in the first interference signal,
obtains, based on a second interference signal obtained from the interference light between the second test light and the reference light that has been detected by the detector, a fractional component of a second phase serving as a phase of the second interference signal at an arbitrary wave number contained in the second interference signal,
obtains a first interference order difference serving as an interference order difference between the first phase and the second phase, based on the slope of the first phase, the fractional component of the first phase, and the fractional component of the second phase, and
obtains the distance based on the first interference order difference, the fractional component of the first phase, and the fractional component of the second phase.

11. The apparatus according to claim 1, wherein the processor obtains, based on a first interference signal obtained from the interference light between the first test light and the reference light that has been detected by the detector, a slope of a first phase serving as a slope of a phase of the first interference signal, and a fractional component of the first phase serving as the phase of the first interference signal at an arbitrary wave number contained in the first interference signal,
obtains, based on a second interference signal obtained from the interference light between the second test light and the reference light that has been detected by the detector, a slope of a second phase serving as a slope of a phase of the second interference signal, and a fractional component of the second phase serving as the phase of the second interference signal at an arbitrary wave number contained in the second interference signal,
obtains a first interference order difference serving as an interference order difference between the first phase and the second phase, based on the slope of the first phase, the fractional component of the first phase, the slope of the second phase, and the fractional component of the second phase, and
obtains the distance based on the first interference order difference, the fractional component of the first phase, and the fractional component of the second phase.

12. The apparatus according to claim 1, wherein the processor obtains, based on a first interference signal obtained from the interference light between the first test light and the reference light that has been detected by the detector, and a second interference signal obtained from the interference light between the second test light and the reference light that has been detected by the detector, a slope of one phase serving as a slope of a phase of the first interference signal and second interference signal, and fractional components of two phases serving as phases of the first interference signal and second interference signal at an arbitrary wave number contained in the first interference signal and second interference signal,
obtains an interference order difference between the first interference signal and the second interference signal, based on the slope of the one phase and the fractional components of the two phases, and
obtains the distance based on the interference order difference and the fractional components of the two phases.
